(19) United States
(12) Patent Application Publication
(10) Pub. No.: US 2010/0162994 A1
(43) Pub. Date: Jul. 1, 2010

(54) VALVE DEVICE AND INTERNAL COMBUSTION ENGINE SYSTEM

(76) Inventors: Alfred Elsäßer, Keltern (DE); Patric Genieser, Stuttgart (DE); Dietmar Türpe, Ilmenau (DE); Michael Löffler, Elleben (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/640,494

(22) Filed: Dec. 17, 2009

(30) Foreign Application Priority Data
Dec. 18, 2008 (DE) 102008063604.5

(51) Int. Cl. F02D 9/08; F16K 31/02; F16K 1/22; F02B 47/08

(52) U.S. Cl. 123/337; 251/129.01; 251/305; 123/568.21

(57) ABSTRACT

The present invention relates to a valve device (13) for controlling a gas flow in a fresh air system (6) of an internal combustion engine (2), in particular of a motor vehicle, with a housing (17) which encloses at least one duct section (19) through which the gas flow (14) can pass transversely to the main flow direction (18), with at least one flap (15) which can be rotated about an axis of rotation (21) which runs transversely with respect to the main flow direction (18) in the duct section (19).

In order to improve the fail-safety of the valve device (13), at least one rotary frame (24) is provided, which can be rotated about an axis of rotation (25) which runs transversely with respect to the main flow direction (18) in the duct section (19) and has a frame opening (26) through which the gas flow (14) can pass. A frame drive (27) is also provided for moving the rotary frame (24) in a rotary manner, wherein the flap (15) is arranged in the rotary frame (24) for controlling the cross section through which flow can pass of the frame opening (26), wherein the rotary frame (24) can be moved by means of the frame drive (27) at least between a starting position, in which the frame opening (26) forms the cross section through which flow can pass of the duct section (19), and an emergency position, in which the cross section through which flow can pass of the duct section (19) comprises at least one bypass path (36) which circumvents the rotary frame (24).

The present invention relates to a valve device for controlling a gas flow in a fresh air system of an internal combustion engine, in particular of a motor vehicle. The invention also relates to an internal combustion engine system for a motor vehicle which has at least one such valve device.

DE 10 2006 037 934 A1 discloses an internal combustion engine system which comprises an internal combustion engine which has a plurality of cylinders and pistons which can be moved in a stroke-like manner therein, a fresh air system for supplying fresh air to the cylinders of the internal combustion engine, an exhaust gas system for discharging exhaust gas from the cylinders of the internal combustion engine and an exhaust gas recirculation system for recirculating exhaust gas from the exhaust gas system to the fresh air system. To improve exhaust gas recirculation, at least one valve device for controlling a flow cross section is arranged in the fresh air system, upstream of inlet valves of the cylinders with respect to the fresh air flow, in the known internal combustion engine system. The respective valve device is actuated or operated in such a manner that it opens the flow cross section of the fresh air system during an admission operation of one of the cylinders only after the start of admission. This means that a vacuum which is produced by the movement of the piston in the cylinder can be used to improve exhaust gas recirculation. The valve device in the known internal combustion engine system can have a continuously rotating, driven flap, which rotates for example synchronously with a crankshaft of the internal combustion engine.

It is in particular possible with the aid of such valve devices to intensify pressure oscillations in the fresh air system, which are present in any case owing to load changing processes, or to create such pressure oscillations. Negative amplitudes of these pressure oscillations can be used to adjust an exhaust gas recirculation rate, that is, at least to change the exhaust gas recirculation rate.

It is theoretically conceivable for such a valve device to have a malfunction or even fail during operation. For example, the flap drive can fail. The flap can stop or become jammed in a position in which the flap closes a large part of the cross section of the duct section through which flow can pass or even blocks it completely. As a consequence the fresh air supply of the internal combustion engine is at great risk, as a result of which the latter can no longer be operated properly or can even fail.

The present invention is concerned with the problem of specifying an improved embodiment for a valve device or for an internal combustion engine system which is equipped therewith, which embodiment is characterised in particular in that operation of the internal combustion engine is still possible in the event of a malfunction of the valve device.

This problem is solved according to the invention by the subject matter of the independent claims. Advantageous embodiments form the subject matter of the dependent claims.

The invention is based on the general idea of arranging a rotary frame in the duct section, which rotary frame can be moved coaxially to the axis of rotation with the aid of a frame drive and has a frame opening, the cross section of which, through which flow can pass, can be controlled using the flap. The rotary frame and the frame drive are matched to each other in such a manner that the frame drive can transfer the rotary frame from a starting position to an emergency position. In the starting position, the frame opening of the rotary frame forms the cross section through which flow can pass of the duct section. In contrast to this, in the emergency position at least one bypass path is opened so that the cross section through which flow can pass of the duct section comprises or has in the emergency position at least this one bypass path which circumvents the rotary frame. In this manner it is ensured using the at least one bypass path that flow can pass through the valve device sufficiently even if the frame opening of the rotary frame is closed due to an unfavourable flap position. A sufficient fresh air supply of the internal combustion engine can thus be realised for emergency operation so that the internal combustion engine can in principle be operated. The exhaust gas recirculation rates which can be realised can deviate from optimal values, which can however be taken into account for this emergency operation.

It is also to be noted at this point that this emergency operation function is integrated in the valve device so that complex measures for realising the same function in the fresh air system can be omitted. For example, a complex bypass which circumvents the valve device and could be activated when the valve device fails is conceivable.

According to an advantageous embodiment, two bypass paths through which flow can pass in parallel and which circumvent the rotary frame on both sides of the axis of rotation can be opened in the emergency position. This means that the structure can be simplified, with it being possible at the same time for a comparatively large cross section through which flow can pass to be opened in the duct section for emergency operation. It is particularly expedient to match the flap and the rotary frame to each other in such a manner that the axis of rotation of the rotary frame runs coaxially to the axis of rotation of the flap. This results in a particularly compact design.

According to an advantageous embodiment, the frame drive can be designed to be fail-safe so that it automatically transfers the rotary frame into the emergency position in the event of a malfunction of the flap. This fail-safe design makes possible an automatic transfer of the rotary frame into the emergency position and thus an automatic provision of a sufficiently dimensioned cross section through which flow can pass in the duct section if the flap no longer operates properly, which can be caused by the flap itself or by its flap drive.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the framework of the present invention.

Preferred exemplary embodiments of the invention are shown in the drawings and are explained in more detail in the following description, with the same reference symbols referring to the same or similar or functionally identical components.

In the figures,

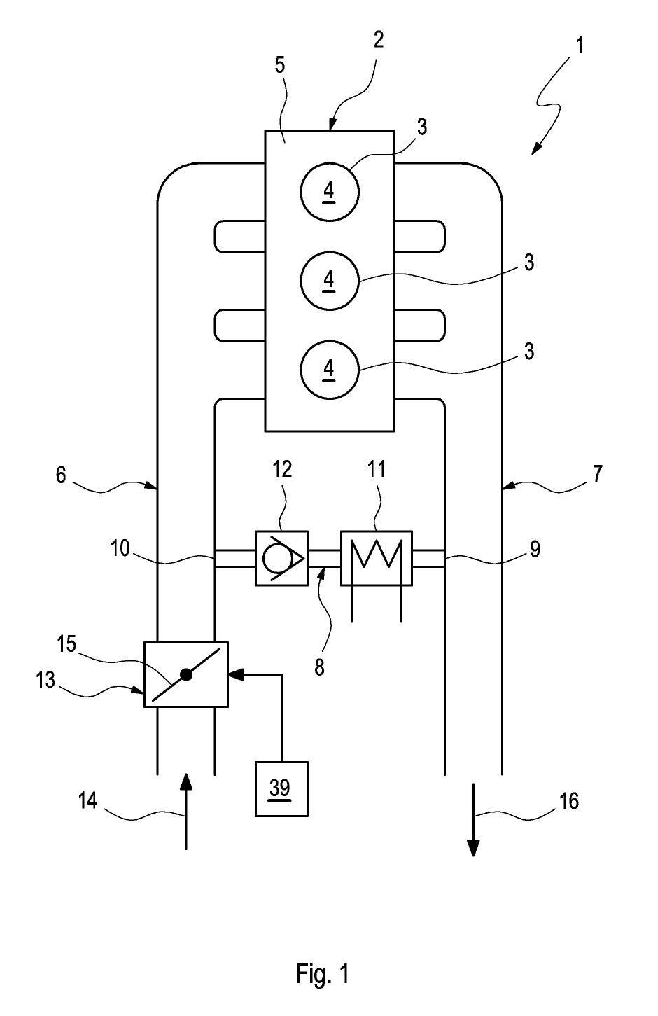

FIG. 1 schematically shows a highly simplified, circuit diagram type basic outline of an internal combustion engine system,

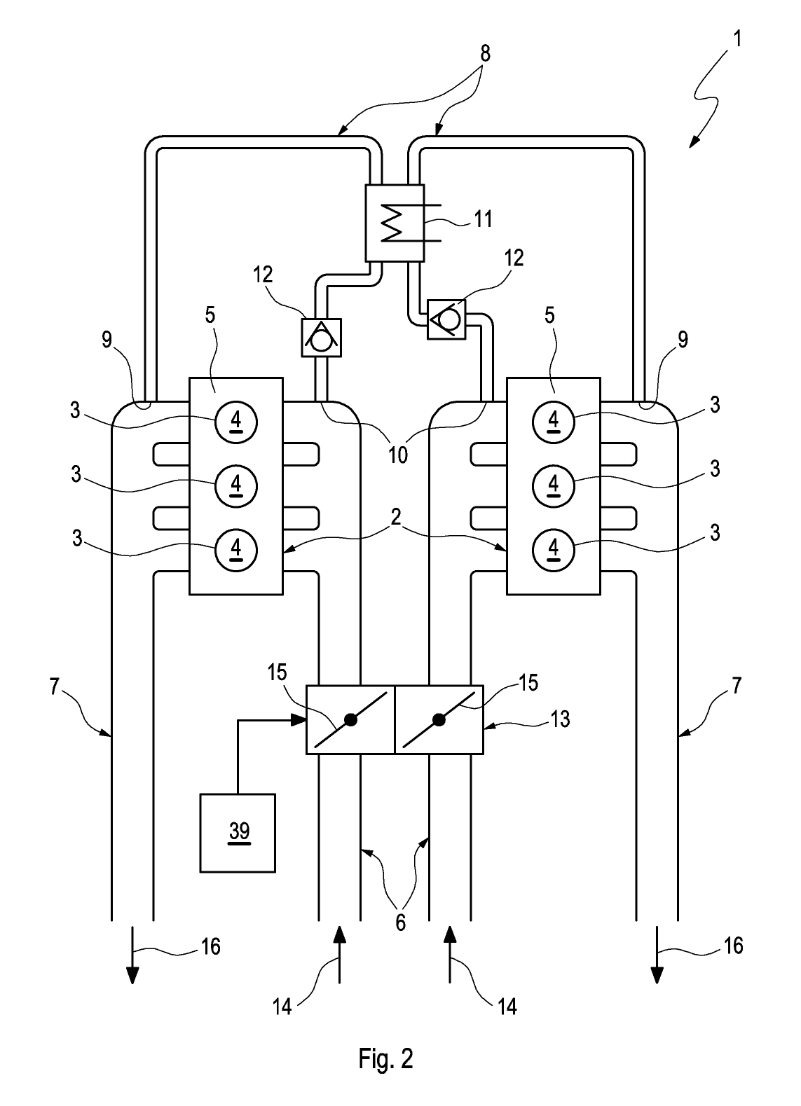

FIG. 2 schematically shows a view as in FIG. 1, but in a different embodiment,

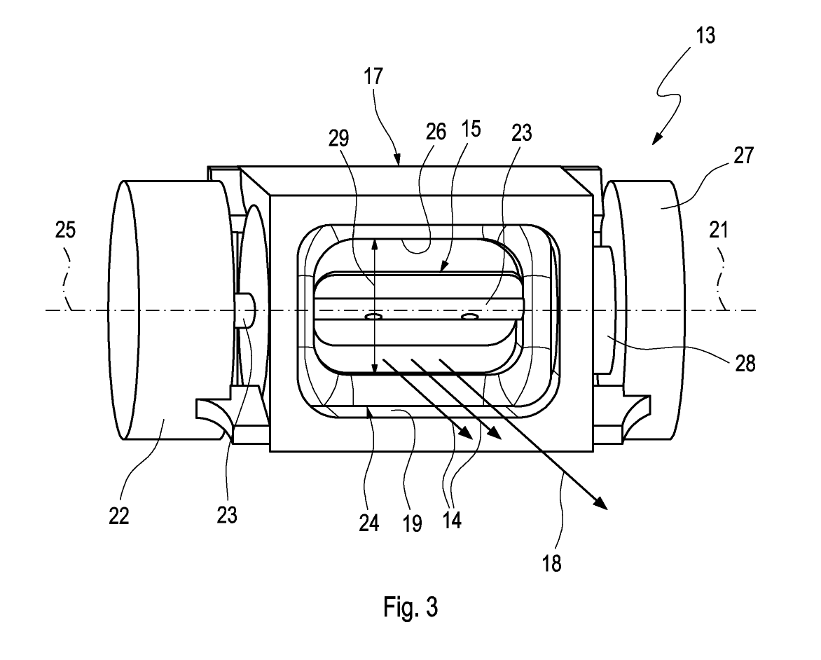

FIG. 3 schematically shows a perspective view of a valve device,

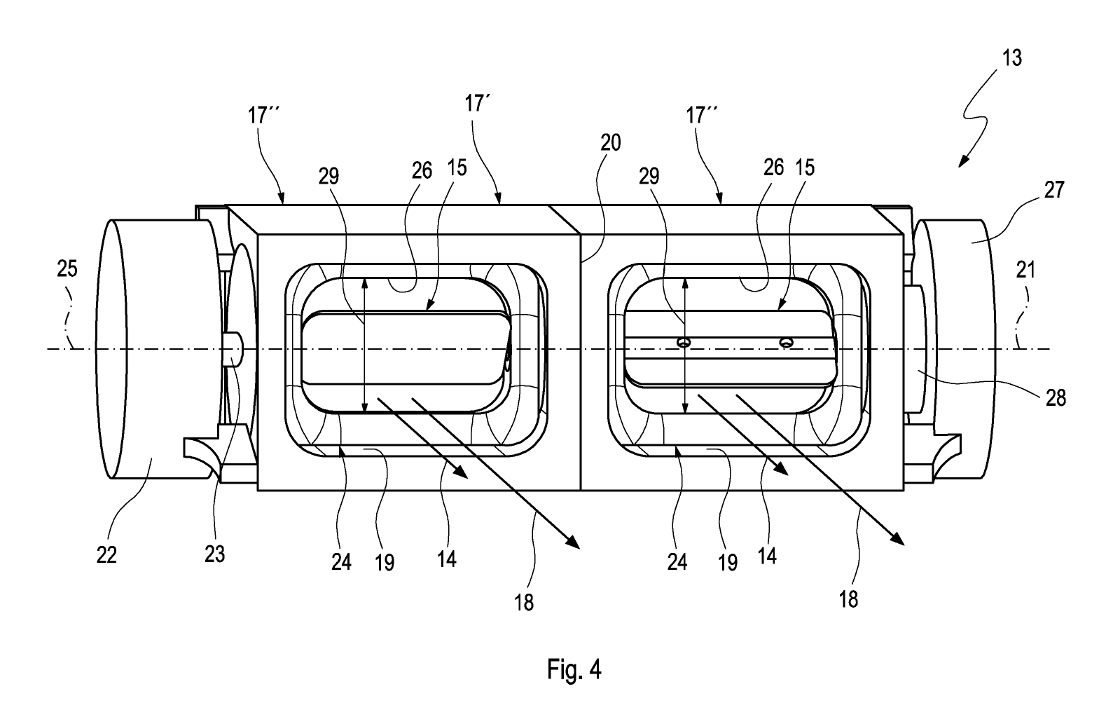

FIG. 4 schematically shows a view as in FIG. 3, but in a different embodiment,

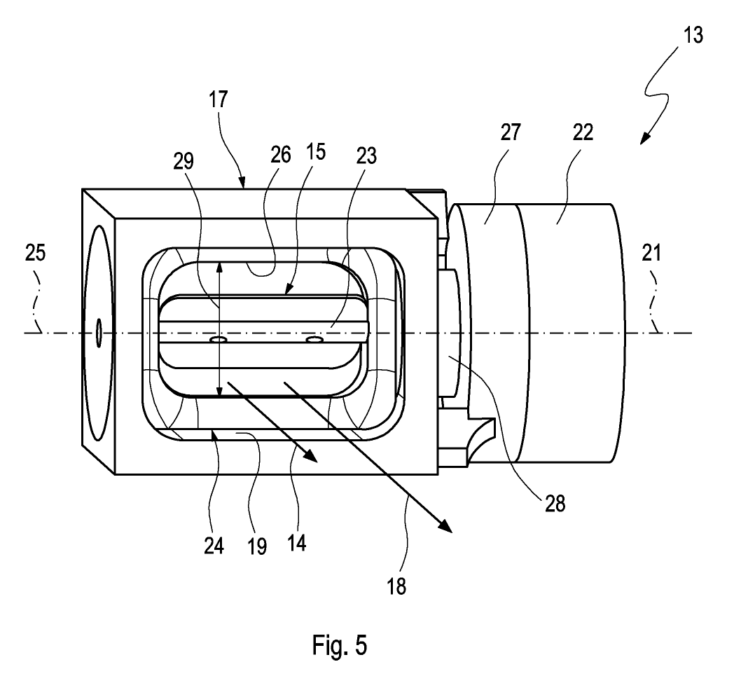

FIG. 5 schematically shows a view as in FIG. 3, but in a further embodiment,

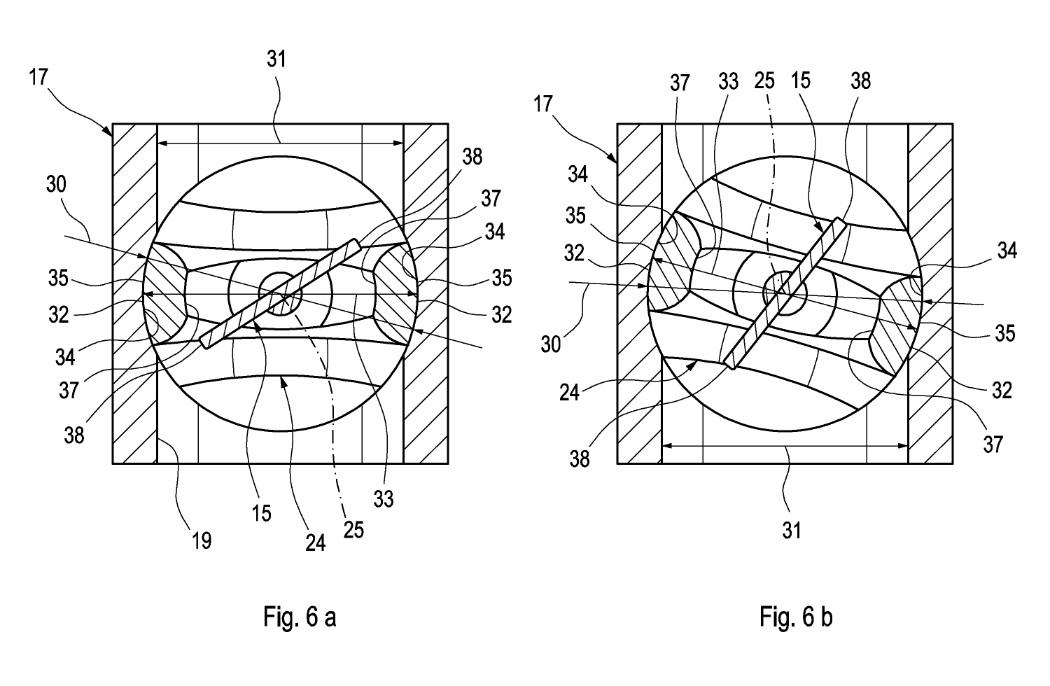

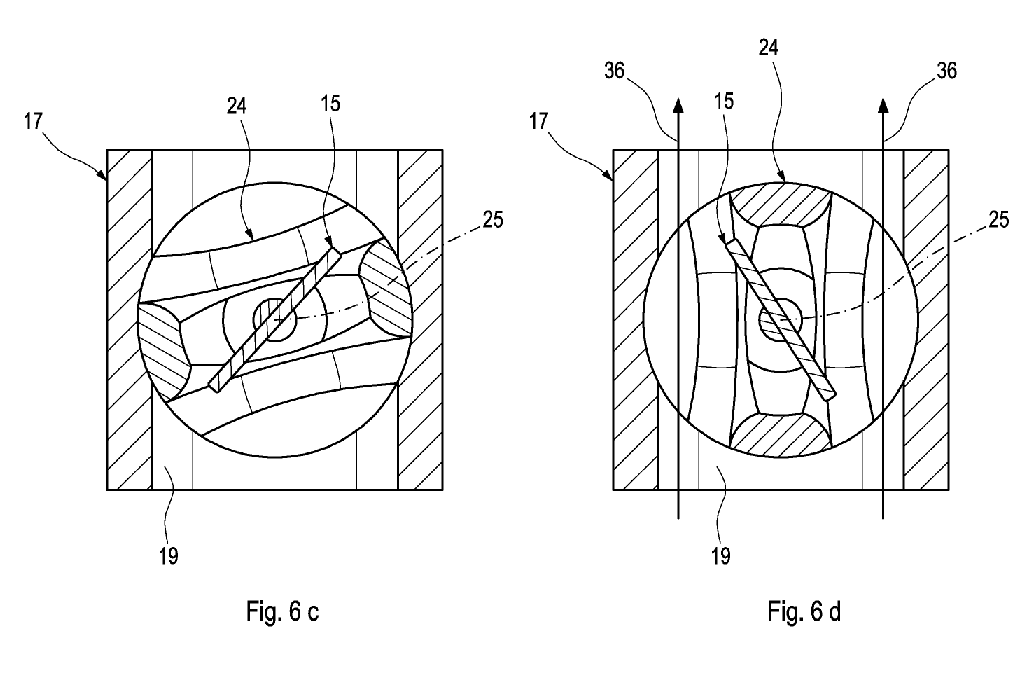

FIGS. 6a-6d in each case schematically show a highly simplified longitudinal section through a valve device in different operating states,

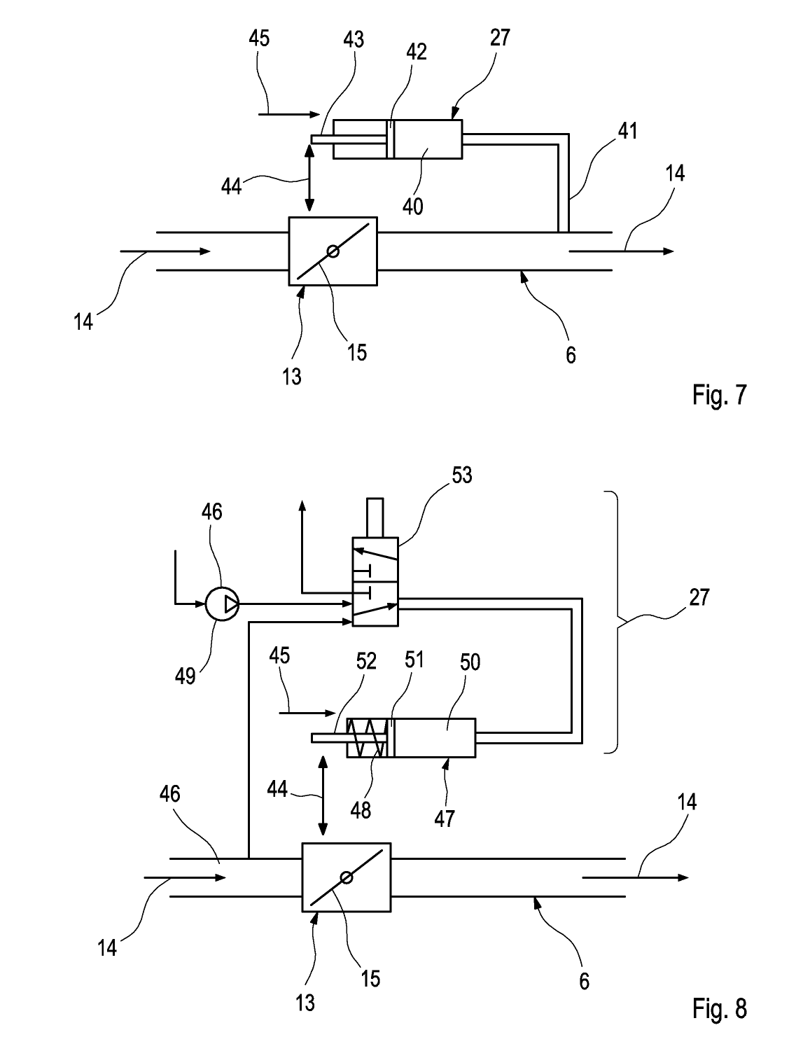

FIGS. 7 to 10 in each case schematically show a highly simplified, circuit diagram type illustration of the valve device with different embodiments of a frame drive.

According to FIGS. 1 and 2, an internal combustion engine system 1, which can be used for example in a motor vehicle, comprises an internal combustion engine 2, which has a plurality of cylinders 3 and pistons 4 which can be moved in a stroke-like manner in the cylinders. In the embodiment shown in FIG. 1 the internal combustion engine 2 comprises a single cylinder bank 5 which contains all the cylinders 3. In the example of FIG. 2 the internal combustion engine 2 has two such cylinder banks 5 which in each case contain a plurality, usually half, of the cylinders 3.

The internal combustion engine system 1 further comprises a fresh air system 6, an exhaust gas system 7 and an exhaust gas recirculation system 8. The fresh air system 6 supplies fresh air to the cylinders 3 during operation of the internal combustion engine 2. The exhaust gas system 7 discharges exhaust gas from the cylinders 3 during operation of the internal combustion engine 2. The exhaust gas recirculation system 8 is used to recirculate exhaust gas from the exhaust gas system 7 to the fresh air system 6. To this end, the exhaust gas recirculation system 8 connects at least one exhaust-side extraction point 9 to at least one fresh air-side introduction point 10. The exhaust gas recirculation system 8 can contain an exhaust gas recirculation cooler 11 and optionally at least one non-return check valve 12 which prevents fresh air from being transferred to the exhaust side.

The internal combustion engine system 1 is also equipped with at least one valve device 13 in the embodiments shown here. This is arranged in the fresh air system 6 upstream of inlet valves (not shown) of the cylinders 3 with respect to a fresh air flow which is indicated by an arrow 14. An exhaust gas recirculation rate of the exhaust gas recirculation system 8 can be varied or adjusted using the valve device 13. The valve device 13 operates with at least one flap 15, which is shown in a highly simplified manner in FIGS. 1 and 2. In the embodiment shown in FIG. 2 the valve device 13 has two such flaps 15, which are in each case associated with a strand of the fresh air system 6, which is configured here with two flows, and which supply the two cylinder banks 5 or their cylinders 3 separately with fresh air. An embodiment is likewise conceivable in which two valve devices 13 are used, which operate in each case with one flap 15. In FIGS. 1 and 2, 16 refers to an exhaust gas flow which is indicated by a corresponding arrow.

According to FIG. 3 to 5 such a valve device 13, with the aid of which a gas flow in the fresh air system 6 can be controlled, comprises a housing 17. This housing 17 encloses a duct section 19, through which the gas flow 14 can pass, transversely with respect to a main flow direction 18, which is indicated by an arrow, of the respective gas flow, in this case the fresh air flow 14. As already explained above with respect to FIGS. 1 and 2, the valve device 13 comprises at least one flap 15. In the embodiments of FIGS. 3 and 5 the valve device 13 has in each case exactly one flap 15. In contrast to this, an embodiment is shown in FIG. 4 in which the valve device 13 has two such flaps 15. In this embodiment two duct sections 19 are also provided, through which a gas flow 14 can pass separately in each case, and which are enclosed by a common housing 17′. This common housing 17′ can be composed of two part housings 17″, for example along a separating plane 20.

The respective flap 15 is arranged in the associated duct section 19 such that it can rotate about an axis of rotation 21. The axis of rotation 21 extends transversely with respect to the main flow direction 18. The valve device 13 has a flap drive 22, with the aid of which the respective flap 15 can be driven in a rotating manner. To this end the flap drive 22 drives a flap shaft 23 which is connected in a rotationally fixed manner to the respective flap 15. In the embodiment shown in FIG. 4 a common flap drive 22 is provided for both flaps 15. Both flaps 15 are connected in a rotationally fixed manner to the same flap shaft 23.

The valve device 13 also has at least one rotary frame 24. This is arranged in the associated duct section 19 such that it can rotate about an axis of rotation 25. The axis of rotation 25 extends coaxially with respect to the axis of rotation 21, that is, the axis of rotation 21 and the axis of rotation 25 coincide. The respective rotary frame 24 has a frame opening 26. In the example of FIG. 4 two such rotary frames 24 are provided which are in each case arranged in one of the duct sections 19.

In order to move the respective rotary frame 24 in a rotary manner, the valve device 13 has a frame drive 27. For the drive-coupling between the frame drive 27 and the respective rotary frame 24, a frame shaft 28 is provided which is connected in a rotationally fixed manner to the rotary frame 24. In the embodiment shown in FIG. 4 both rotary frames 24 are connected in a rotationally fixed manner to the frame shaft 28. To this end, the rotary frame 24 which is shown on the right in FIG. 4 and is arranged close to the frame drive 27 can for example be connected directly to the frame shaft 28, whereas the rotary frame 24 which is shown on the left in FIG. 4 and is at a distance from the frame drive 27 can be connected in a rotationally fixed manner by means of a hollow intermediate shaft to the rotary frame 24 which is arranged close to the frame drive 27. The flap shaft 23 can then be guided coaxially through the hollow intermediate shaft between the two flaps 15. The hollow intermediate shaft cannot be seen in FIG. 4.

The respective flap 15 is arranged in the associated rotary frame 24, in such a manner that it can control a cross section 29 through which flow can pass of the frame opening 26. In other words, the cross section 29 through which flow can pass can be blocked or opened by the flap 15 depending on the relative rotary position between the flap 15 and the associated rotary frame 24. In the respective blocked position, a gap can be present radially between the flap 15 and the rotary frame 24, which gap can be configured in particular as a throttling sealing gap and realises a sufficient sealing or blocking effect.

According to FIG. 3 to 5, the flap drive 22 is arranged on the outside of the housing 17 and supported in a rotationally fixed manner on the housing 17. This rotary support between the flap drive 22 and the housing 17 or 17′ or 17″ takes place directly in the embodiments of FIGS. 3 and 4, whereas it takes place indirectly in the embodiment shown in FIG. 5. The frame drive 27 is arranged on the outside of the housing 17 and also supported in a rotationally fixed manner on the housing 17. The rotationally fixed support between the frame drive 27 and the housing 17 or 17′ or 17″ takes place directly in the embodiments of FIG. 3 to 5. In the embodiments of FIGS. 3 and 4, the two drives 22, 27 are arranged on sides of the housing 17 or 17′ which face away from each other. In contrast to this, FIG. 5 shows an embodiment in which the two drives 22, 27 are arranged on the same side of the housing 17. In order to realise this, the frame shaft 28 is configured as a hollow shaft so that the flap shaft 23 can be guided coaxially through the frame shaft 28. At the same time the flap shaft 23 extends also coaxially through the frame drive 27. In this embodiment the flap drive 22 is fixed to the frame drive 27 and thus supported in a rotationally fixed manner on the housing 17 by means of the frame drive 27 and thus indirectly.

FIG. 6a to 6d show longitudinal sections through the valve device 13 in the region of the flap 15 or in the region of one of the flaps 15. According to FIG. 6a to 6d, the rotary frame 24 has an outer cross section 30 which is greater than an inner cross section 31 which the duct section 19 has upstream or downstream of the rotary frame 24. The housing 17, which can also in principle be the whole housing 17′ or one of the part housings 17″, has two cut-outs 32 on its inner side which bounds the duct section 19, which cut-outs are diametrically opposite each other. An inner cross section 33 of these cut-outs 32 is matched to the outer cross section 30 of the rotary frame 24 in such a manner that the rotary frame 24 can rotate or dip into the cut-outs 32. Furthermore, an inner contour 34 of the cut-outs 32 and an outer contour 35 of the rotary frame 24 are matched to each other in such a manner that they interact in a sealing manner, as long as they are at least partially radially opposite each other, which is the case in FIG. 6a to 6c. As long as the inner contour 34 and the outer contour 35 are at least partially radially opposite each other and thus interact in a sealing manner, the rotary frame 24 is in an overlap angle area which contains all the relative rotary positions between the rotary frame 24 and the housing 17 in which the sealing interaction of the inner contour 34 and the outer contour 35 can take place. As long as the rotary frame 24 is within this overlap angle region, no bypass flow which circumvents the rotary frame 24 outside its frame opening 26 takes place. Such a bypass flow is indicated in FIG. 6 by arrows 36. In the relative position between the rotary frame 24 and the housing 17 reproduced in FIG. 6d, the rotary frame 24 is in an emergency position which allows flow to pass around the rotary frame 24 with the lowest possible flow resistance. This emergency position is rotated by 90° with respect to a starting position which is reproduced in FIG. 6a. In this starting position, a plane (not shown here) in which the rotary frame 24 encloses its frame opening 26 extends perpendicularly to the main flow direction 18 which corresponds to an axial direction of the duct section 19.

The above-mentioned overlap angle region can comprise a rotary angle region of maximally 80° or of maximally 60°. FIG. 6b shows a state in which the rotary frame 24 is rotated by approximately 15° in one direction out of the starting position according to FIG. 6a. In contrast to this, FIG. 6c shows a state in which the rotary frame 24 is rotated by approximately 15° in the opposite direction out of the starting position according to FIG. 6a. In both cases the rotary frame 24 is still clearly within the overlap angle region.

According to FIG. 6a to 6d, the inner contour 34 of the cut-outs can expediently be configured in a cylindrical segment shape. Correspondingly, the outer contour 35 of the rotary frame 24 can expediently be configured in a cylindrical segment shape. It is furthermore advantageous to configure the overlap angle region to be symmetrical to the starting position according to FIG. 6a. In this manner, the rotary frame 24 can be moved to the same extent in both directions of rotation without leaving the overlap angle region.

An inner contour 37 of the rotary frame 24 can be matched to an outer contour 38 of the flap 15 in such a manner that they interact in a sealing manner in order to be able to realise the said blocking effect for the closed position of the flap 15.

Sealing interaction between the inner contour 37 and the outer contour 38 is however only possible as long as the flap 15 is within a closing angle region which is present in rotary positions between the flap 15 and the rotary frame 24 in which the inner contour 37 and the outer contour 38 are at least partially radially opposite each other. As already mentioned above, a gap, in particular a throttling sealing gap, can remain between the inner contour 37 and the outer contour 38 within this closing angle region. The said closing angle region can for example comprise a rotary angle region of maximally 40° or of maximally 30°. In particular, the closing angle region can be approximately half the size of the above-mentioned overlap angle region.

According to FIGS. 1 and 2, the valve device 13 can also have a control system 39 which is coupled at least to the respective frame drive 27 in order to operate it, that is, to actuate the rotary movement of the rotary frame 24. The frame drive 27 is for example an electric motor. The flap drive 22 can in principle likewise be an electric motor which can in principle likewise be operated by means of the control system 39. Alternatively, it is likewise possible for the flap drive 22 to be formed by a mechanical coupling to a shaft which is driven in a rotary manner by the internal combustion engine 2. For example, a camshaft or a crankshaft can be used to drive the respective flap 15 synchronously to the speed of the crankshaft. The flap drive 22 can for example be realised by a belt drive or by a gear drive or by a chain drive. The direct or indirect mechanical coupling of the at least one flap 15 to the crankshaft of the internal combustion engine 2 means that the flap speed in necessarily synchronised for all speeds of the crankshaft.

The frame drive 27 can then be configured in such a manner that it can move the rotary frame 24 only between the starting position shown in FIG. 6a and the emergency position shown in FIG. 6d. Optionally, the frame drive 27 can also be configured in such a manner that it can realise other positions in addition to the two said positions, namely the starting position and the emergency position, as are shown for example in FIGS. 6b and 6c. In principle, any other desired positions are also conceivable. These further positions are explained in more detail below.

In the starting position according to FIG. 6a, the cross section through which flow can pass of the duct section 19 is only formed by the frame opening 26. The cross section through which flow can pass of the duct section 19 can then be controlled using the flap 15 which interacts to this end with the frame opening 26. In the emergency position according to FIG. 6d, the cross section through which flow can pass of the duct section 19 comprises at least one bypass path 36 which circumvents the rotary frame 24. In the preferred example shown, two such bypass paths 36 are open in the emergency position, through which flow can pass in parallel and which circumvent the rotary frame 24 on both sides of the axis of rotation 25. FIGS. 6a and 6d also show that the rotary frame 24 in the emergency position is rotated by 90° with respect to the starting position. The angle between the emergency position and the starting position is preferably in a range from 80° to 100° inclusive.

As already explained above, the outer contour 35 of the rotary frame 24 in the starting position 6a—as in the rotary positions of FIGS. 6b and 6c which differ from this and likewise fall within the overlap angle region—interacts in a sealing manner with the inner contour 34 of the duct section 19 or of the cut-outs 32 so that in the starting position (and in the rest of the overlap angle region) the bypass paths 36 are closed.

The control system 39 can then be configured and programmed corresponding to an advantageous use of the valve device 13 presented here in such a manner that it can realise the operating method explained in more detail below.

The flap drive 22 drives the respective flap 15 in a rotary manner synchronously with the speed of the crankshaft. This synchronisation is designed in a targeted manner in such a manner that an exhaust gas recirculation rate which is sufficient on average is set for all speed ranges of the crankshaft. This applies in particular when the rotary frame 24 is in its starting position. If the exhaust gas recirculation rate is to be varied, that is, increased or decreased, as a function of predefined operating states of the internal combustion engine 2, this can be realised by changing a closing time window of the valve device 13. This closing time window is defined by a closing time, an opening time and a closing duration which defines the chronological difference between the closing time and the opening time. The closing time is present when the flap 15 enters the closing angle region. The opening time is present when the flap 15 exits again from the closing angle region. The closing time window can be brought forward and pushed back in time using the frame drive 27. With an invariant closing duration, the closing time and the opening time are brought forward or pushed back at the same time. In order to bring the closing time or the closing time window forward, the control system 39 operates the frame drive 27 in such a manner that it turns the rotary frame 24 by an adjustable angle counter to the direction of rotation of the flap 15. This angle of rotation depends on the time span by which the closing time or the closing time window is to be brought forward. The turning of the rotary frame 24 counter to the direction of rotation of the flap 15 means that the flap 15 enters the closing angle region earlier than the starting position. If, in contrast, the closing time or the closing time window are to be pushed back, the control system 39 operates the frame drive 27 in such a manner that it turns the rotary frame 24 by an adjustable angle in the direction of rotation of the flap 15. This angle of rotation also depends on the time span by which the closing time or the closing time window is to be pushed back. The angles of rotation which can be set for bringing the closing time window forward or pushing it back are within the above-mentioned overlap angle region. The setting of the angle or the rotary position between the rotary frame 24 and the housing 17 can be static and be maintained for a predefined time span which can depend on the respective operating state of the internal combustion engine 2. The static change in the rotary position of the rotary frame 24 means that the closing duration of the valve device 13 does not change. Should it however be necessary for certain operating states of the internal combustion engine 2 to vary, that is, to lengthen or shorten, the closing duration, this can likewise be realised with the aid of the frame drive 27. As long as the flap 15 is in the closing angle region, the control system 39 can actuate the frame drive 27 in such a manner that it turns the rotary frame 24 counter to the direction of rotation of the flap 15 with an adjustable rotary speed. This relative turning of the rotary frame 24 counter to the flap 15 means that the closing duration of the valve device 13 is shortened. The rotary speed of the rotary frame 24 depends on the value by which the closing duration is to be shortened. If however a lengthening of the closing duration is desired, as long as the flap 15 is in the closing angle region, the control system 39 can actuate the frame drive 27 in such a manner that it turns the rotary frame 24 with the direction of rotation of the flap 15 with an adjustable rotary speed. The relative turning of the rotary frame 24 with the flap 15 means that the closing duration is lengthened correspondingly. In this case too the rotary speed of the rotary frame 24 depends on the value by which the closing duration of the valve device 13 is to be lengthened.

During such an operation to shorten or lengthen the closing duration, as soon as the flap 15 leaves the closing angle region the control system 39 can operate the frame drive 27 in such a manner that the rotary frame 24 is moved back into its starting position during this comparatively large opening time window.

The sealing of a gap between the rotary frame 24 and the housing 17 can for example be realised by means of movable sealing strips which can for example slide in the duct section 19 of the housing 17. A sealing effect could furthermore be realised by measures which lead to a greater increase in the flow resistance in the gap, what are known as surface profiles. Furthermore, a separating seal can be realised between the respective housing 17, 17′ and a directly connected or continuous rotary frame 24 according to FIG. 4 for example by piston-ring-shaped sealing rings (not shown here).

The emergency position shown in FIG. 6d can then be set if the valve device 13 is to be put out of operation or transferred into an emergency mode due to a corresponding error message. Furthermore, this emergency position can also be used to synchronise the valve device 13.

In an alternative solution, the rotary frame 24 can be omitted. The rotary drive 27 is then used as an additional drive with which the relative position of a housing or a stator of the flap drive 22 can be changed with respect to the housing 17. Changing the relative position between the housing 17 and the housing/stator of the flap drive 22 means it is likewise possible to bring forward and push back the closing time window. For variation of the closing duration, the additional drive can drive the housing of the flap drive 22 with or counter to the direction of rotation of the flap 15, as a result of which the speed of the additional drive is either added to the speed of the flap 15 or subtracted from it.

The frame drive 27 can be designed to be fail-safe in accordance with a preferred embodiment. This means that it transfers the rotary frame 24 automatically into the emergency position when there is a malfunction of the flap 15, which can be caused by the flap 15 itself or by the flap drive 22. This means that increased operational reliability is realised. Different embodiments for the frame drive 27, which are designed in particular to be fail-safe, are explained in more detail below with reference to FIG. 7 to 10.

According to FIG. 7, the frame drive 27 can operate pneumatically. To this end it can for example be configured as a piston/cylinder assembly, the cylinder 40 of which can for example be connected in a communicating manner to the fresh air system 6. To this end, a pneumatic connection line 41 is attached to the fresh air system 6 downstream of the flap 15 with respect to the fresh air flow 14. The cylinder 40 can likewise be attached to the duct section 19 of the valve device 13 downstream of the flap 15. A piston 42 which is arranged such that it can be moved in a stroke-like manner in the cylinder 40 is drive-connected to the rotary frame 24 by means of a piston rod 43. This drive-connection is indicated in FIG. 7 by a double arrow and referred to with 44. If an impermissibly high vacuum is now produced downstream of the flap 15, for example if the flap 15 stops or becomes jammed in the closing angle region, the pressure downstream of the flap 15 falls below a predefined limit value. This leads to the frame drive 27 being operated. The vacuum in the cylinder 40 drives the piston 42 and thus the piston rod 43 in accordance with an arrow 45, as a result of which the rotary frame 24 is transferred into the emergency position by means of the drive coupling 44.

According to FIG. 8, in another embodiment the frame drive 27 can have a pneumatically or hydraulically operating pressure generator 46, a pneumatically or hydraulically operating actuator 47 and a restoring device 48 which operates without an external energy source. The actuator 47 is again drive-connected to the rotary frame 24 by means of a suitable drive coupling 44. The restoring device 48, which can for example be formed by a spring, is drive-coupled to the actuator 47 or directly to the rotary frame 24. Two different variants for the pressure generator 46 are shown in FIG. 8. On the one hand, the pressure prevailing in the fresh air system 6 downstream of the respective charging device, for example a turbocharger, can be used in particular in a charged up internal combustion engine 2 so that ultimately the fresh air system 6 itself forms the pressure generator 46. Alternatively, a separate pressure generator 46, for example in the form of a pump 49, can be provided in order to produce the desired hydraulic or pneumatic pressure. The actuator 47 is configured in this case by way of example as a piston/cylinder assembly again and thus comprises a cylinder 50, a piston 51 which can be moved therein and is coupled via the functional connection 44 to the rotary frame 24 by means of a piston rod 52. The frame drive 27 can further have a valve 53 which can be operated electrically or pneumatically or hydraulically.

During normal operation the respective pressure generator 46 loads the actuator 47, in particular in a manner controlled by the valve 53, with a pressure which is selected to be such that the actuator 47 transfers the rotary frame 24 into the starting position counter to a restoring force of the restoring device 48 and holds it there. If emergency operation now occurs, the pressure generator 46 releases the actuator 47, which is preferably controlled by means of the valve 53. As a result, the restoring device 48 can deploy its restoring effect in order to transfer the rotary frame 24 into the emergency position and hold it there. The movement of the piston rod 52 which transfers the rotary frame 24 into the emergency position during emergency operation is indicated in FIG. 8 by an arrow 45 again.

The frame drive 27 can have an electric motor in accordance with the embodiments of FIGS. 3 to 5 and 9. This electric motor, which can likewise be referred to below with 27, can for example be configured as a brushless DC motor. The electric motor 27 can in particular be equipped with position detection, what is known as coding, as a result of which the electric motor 27 or the associated control system 39 always knows the exact rotary position of the electric motor 27 and thus the rotary frame 24. The electric motor 27 can be arranged externally, that is, on the outside of the housing 17, in accordance with FIG. 3 to 5. The torque transmission then takes place by means of the frame shaft 28.

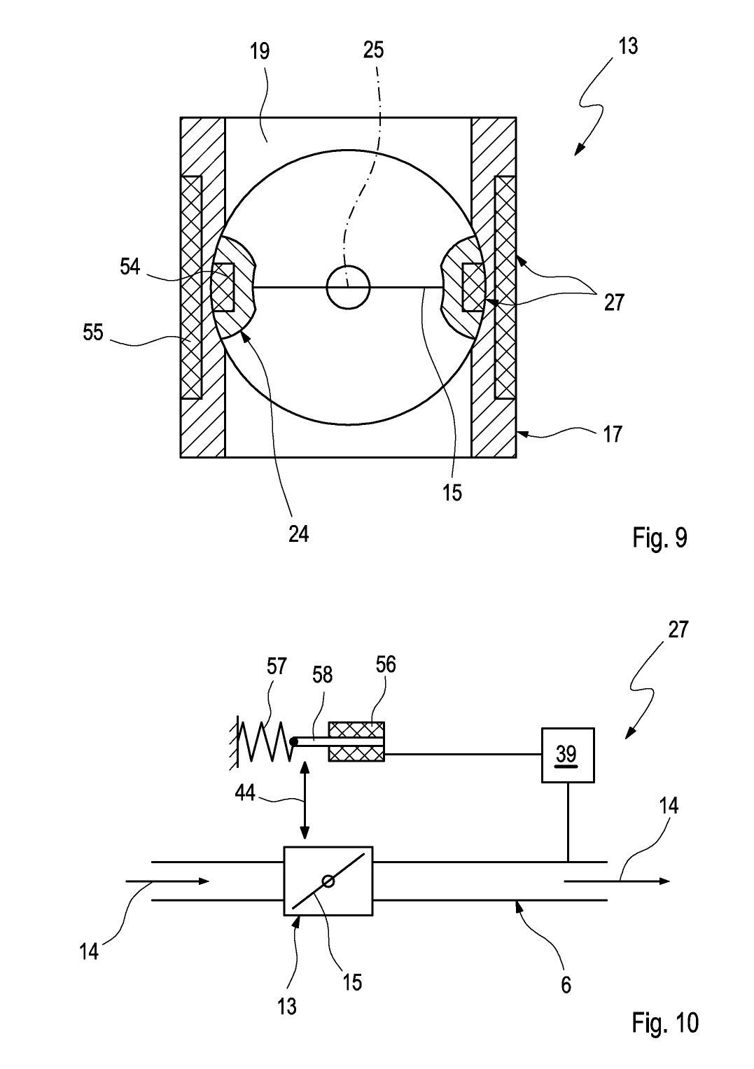

Alternatively, the electric motor 27 can according to FIG. 9 be integrated more or less in the housing 17, as a result of which a particularly compact design can be realised. In the embodiment shown in FIG. 9, the rotary frame 24 is configured as a rotor of the electric motor 27. To this end, the rotary frame 24 can in particular be equipped with a rotor winding 54. The housing 17 can be configured as a stator of the electric motor 27. To this end it can in particular be equipped with a stator winding 55. Corresponding supply of current to the stator winding 55 and/or the rotor winding 54 makes it possible to turn the rotary frame rotor 24 relative to the housing stator 17. It is also possible in the embodiment shown in FIG. 9 to configure the integrated electric motor 27 as a brushless DC motor or as what is known as a switched reluctance motor.

FIG. 10 shows an embodiment in which the frame drive 27 has an electromagnetic actuator 56 and a restoring device 57 which operates without an external energy source. The restoring device 57 can expediently be formed by a spring or by a spring arrangement. The actuator 56 is for example an electromagnet or a solenoid. The actuator 56 is drive-connected in a suitable manner to the rotary frame 24. A corresponding coupling is indicated in FIG. 10 by a double arrow 44 again. The restoring device 57 is drive-connected either to the actuator 56 or to the rotary frame 24. In the example, the restoring device 57 is coupled to an actuating member 58 of the actuator 56. When current is supplied, the actuator 56 transfers the rotary frame 24 into the starting position counter to the restoring force of the restoring device 57 and can hold it there. The holding current can be reduced compared to the current needed for attraction. The actuator 56 can likewise be operated by the control system 39. If the current supply to the actuator 56 drops or is ended, the restoring device 57 can transfer the rotary frame 24 into the emergency position and hold it there. Such an emergency situation can for example be determined by the control system 39 by means of a corresponding sensor system. The control system 39 can for example monitor the pressure in the fresh air system 6 downstream of the flap 15.

1. A fresh air system gas flow valve control device, comprising:
a housing, which encloses at least one gas flow duct section, and configured to receive a gas flow, such that the gas flows transversely to a main flow direction;
at least one flap, configured to be rotated about a first axis of rotation and configured to run transversely to the main flow direction of the duct section;
at least one rotary frame configured to be rotated about a second axis of rotation and configured to run transversely with respect to the main flow direction in the duct section wherein the at least one rotary frame includes a frame opening configured for gas flow passage; and
a frame drive configured to move the rotary frame in a rotary manner, wherein the flap is configured in the rotary frame for controlling a frame opening cross section through which flow passes, wherein the frame drive is configured to move the rotary frame at least between a starting position, wherein the frame opening cross section is configured for flow passage through the duct section, and an emergency position, wherein the cross section is configured for flow passage through the duct section and at least one bypass path is included and configured to circumvent the rotary frame.

2. The valve control device according to claim 1, wherein the emergency position includes at least two parallel bypass paths, wherein the two paths are opened, and configured to circumvent the rotary frame on at least one side of the second axis of rotation.

3. The valve control device according to claim 1, wherein the rotary frame in the emergency position is rotated by approximately 90°+10° compared to the starting position.

4. The valve control device according to claim 1, wherein the outer contour of the rotary frame in the starting position interacts in a sealing manner with an inner contour of the duct section and closes the at least one bypass path.

5. The valve control device according to claim 1, wherein the frame drive is configured to be fail-safe and it automatically transfers the rotary frame into the emergency position in the event of a malfunction of the flap.

6. The valve control device according to claim 1, wherein the frame drive operates pneumatically and is controlled by a vacuum, which builds up downstream of the flap when the flap is closed and the rotary frame is shifted into the starting position, such that the frame drive moves the rotary frame into the emergency position if the vacuum falls below a predefined limit value.

7. The valve control device according to claim 1, wherein the frame drive comprises at least one of a pneumatic and hydraulic pressure generator, a pneumatic and hydraulic actuator and a restoring device configered to operate without an external energy source, wherein the actuator is drive-connected to the rotary frame, the restoring device is at least on of drive-coupled to the actuator and to the rotary frame, during normal operation the pressure generator loads the actuator with pressure, in a valve-controlled manner, such that the actuator transfers the rotary frame into the starting position counter to the restoring force of the restoring device and holds it there, and during emergency operation the pressure generator releases the actuator in a valve-controlled manner, such that the restoring device transfers the rotary frame into the emergency position and holds it there.

8. The valve control device according to claim 1, wherein the frame drive includes an electric motor.

9. The valve control device according to claim 8, wherein the rotary frame is configured as a rotor of the electric motor, wherein the rotary frame includes a rotor winding.

10. The valve control device according to claim 8, wherein the housing is configured as a stator of the electric motor, wherein the housing includes a stator winding.

11. The valve control device according to claim 1, wherein the frame drive includes an electromagnetic actuator and a restoring device, which operates without an external energy source, such that the actuator is drive-connected to the rotary frame, the restoring device is at least one of drive-connected to the actuator and to the rotary frame, wherein current is supplied to the actuator, which transfers the rotary frame into the starting position counter to a restoring force of the restoring device and holds it there, and when the current supply to the actuator stops, the restoring device transfers the rotary frame into the emergency position and holds it there.

12. The valve control device according to claim 1, wherein the rotary frame is rotatable with respect to the duct section within a closing angle region, which includes the starting position, wherein the rotary frame closes the bypass path within the closing angle region.

13. The valve control device according to claim 12, wherein the closing angle region comprises at least one of a maximum of 80° and a maximum of 60°.

14. The valve control device according to claim 12, wherein the rotary frame includes an outer contour configured in a cylindrical segment shape and cooperating with an inner contour of the duct section to establish said closing angle region, such that said inner contour is configured complementary to said outer contour in a cylindrical segment shape.

15. The valve control device according to claim 14, wherein the duct section comprises at least one of two diametrally opposing cut-outs and said inner contour.

16. The valve control device according to claim 1, wherein the flap is rotatable with respect to the rotary frame within a closing angle region, such that the flap closes said frame opening.

17. The valve control device according to claim 16, wherein the closing angle region comprises at least one of a maximum of 40° and a maximum of 30°.

18. The valve control device according to claim 16, wherein the flap includes an outer contour cooperating with an inner contour of the rotary frame to establish said closing angle region, said inner contour is configured in a cylindrical segment shape.

19. An internal combustion engine system, comprising:
a fresh air system configured to supply fresh air to at least one cylinder of an internal combustion engine;
an exhaust gas system configured to discharge exhaust gas from the cylinders of the internal combustion engine;
an exhaust gas recirculation system configured to recirculate exhaust gas from the exhaust gas system to the fresh air system; and
at least one valve device, which is arranged upstream of an inlet valve of the cylinders with respect to the fresh air flow in the fresh air system and is configured to change an exhaust gas recirculation rate.
